(19) United States
(12) Patent Application Publication
(10) Pub. No.: US 2014/0175113 A1
(43) Pub. Date: Jun. 26, 2014

(54) VENDING MACHINE WITH LOCKING ASSEMBLY

(71) Applicants: HON HAI PRECISION INDUSTRY CO., LTD., Wuhan (CN); HONG FU JIN PRECISION INDUSTRY (WUHAN) CO., LTD., Wuhan (CN)

(72) Inventors: YUN-LUNG CHEN, New Taipei (TW); LI TONG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/968,158

(22) Filed: Aug. 15, 2013

(30) Foreign Application Priority Data
Dec. 26, 2012 (CN) 2012105739218

(51) Int. Cl. E05B 65/46; G07F 11/38

(52) U.S. Cl. CPC E05B 65/464; G07F 11/38
USPC 221/154

(57) ABSTRACT

A dispensing device for a vending machine includes an installation member, a goods channel module, and a locking assembly. The goods channel module is slidably secured to the installation member. The locking assembly is secured to the goods channel module and includes a sliding member. The sliding member is slidable into the installation member to lock the installation member to the goods channel module. The sliding member is further slidable out of the installation member, allowing the installation member to be removed from the goods channel module.

### BACKGROUND

1. Technical Field

The present disclosure relates to vending machines, and particularly to a vending machine with a locking assembly.

2. Description of Related Art

In many direct type vending machines, each vending machine includes a chassis and a number of goods channel modules secured to the chassis. Generally, each goods channel module is secured to the frame by screws, which is inconvenient and time-consuming when in assembly or disassembly of the goods channel modules to the frame. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a part of a vending machine.

FIG. 2 is an assembled, isometric view of the vending machine of FIG. 1, with a sliding member in a first position.

FIG. 3 is another assembled, isometric view of the vending machine of FIG. 1, with the sliding member in a second position.

FIG. 4 is an assembled, isometric view of one embodiment of a vending machine, with the sliding member in the first position.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

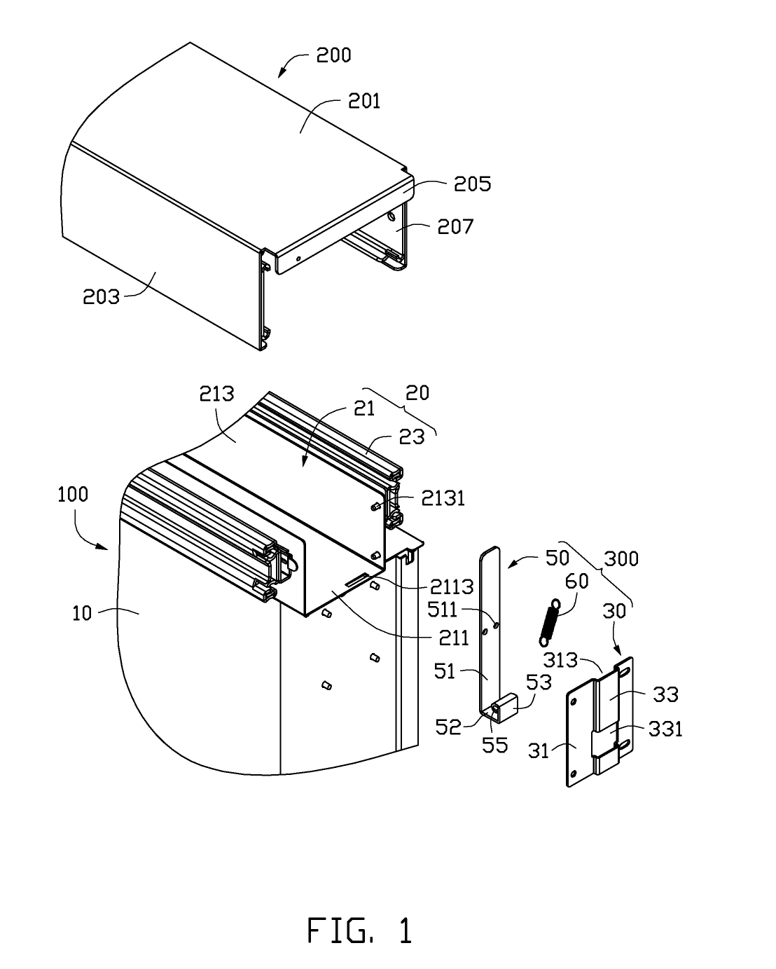

FIG. 1 shows one embodiment of a part of a vending machine. The vending machine includes a plurality of goods channel modules 100 (only one of the goods channel modules 100 is shown), an installation member 200, and a locking assembly 300.

The goods channel module 100 includes a channel case 10 and a sliding assembly 20 secured to the channel case 10. The channel case 10 defines a goods channel (not shown) therein for securing goods. The sliding assembly 20 includes a frame 21 and two sliding rails 23 secured to two sides of the frame 21. The frame 21 includes a bottom plate 211 and two side plates 213 extending perpendicularly from the bottom plate 211. The bottom plate 211 is secured to the channel case 10 and defines an insertion slot 2113. Each sliding rail 23 is mounted outside of one of the two side plates 213. Two posts 2131 extend from one of the two side plates 213. The two posts 2131 and the sliding rail 23 are located on two opposite sides of the side plates 213. The two posts 2131 can be integrated with the side plate 213. The two posts 2131 can also be screws, which are inserted through the side plate and secure the sliding rail 23 to the side plate 213, so that there is no need to set extra two posts 2131 from the side plate 213. In one embodiment, the insertion slot 2113 is substantially rectangular.

The installation member 200 is secured to a chassis (not shown) and includes a top wall 201 and two sidewalls 203. In one embodiment, each sidewall 203 is substantially perpendicular to the top wall 201. A limiting plate 205 extends from a side edge of the top wall 201. Each sidewall 203 defines a slideway 207 for the sliding rail 23 to slide along. In one embodiment, the limiting plate 205 is substantially perpendicular to the top wall 201 and the sidewalls 203, and the top wall 201 is substantially perpendicular to the sidewalls 203.

The locking assembly 300 includes a mounting member 30, a sliding member 50, and a resilient member 60.

The mounting member 30 includes a mounting plate 31 and a receiving portion 33 protruding from a center of the mounting plate 31. The mounting plate 31 defines a receiving slot 313, from which the receiving portion 33 protrudes. The receiving portion 33 defines an opening 331. In one embodiment, each of the receiving slot 313 and the receiving portion 33 is substantially “U” shaped.

The sliding member 50 includes a sliding piece 51, a connecting piece 52, and an operation piece 53. The sliding piece 51 and the operation piece 53 extend perpendicularly from opposite edges of the connecting piece 52. The sliding piece 51 is substantially parallel to the operation piece 53 and defines a mounting hole 511. A rolled portion 55 extends from a top edge of the operation piece 53 towards the sliding piece 51, in order to avoid scuffing.

The resilient member 60 is used for resiliently securing the sliding member 50 to the goods channel module 100. In one embodiment, the resilient member 60 is an extension spring.

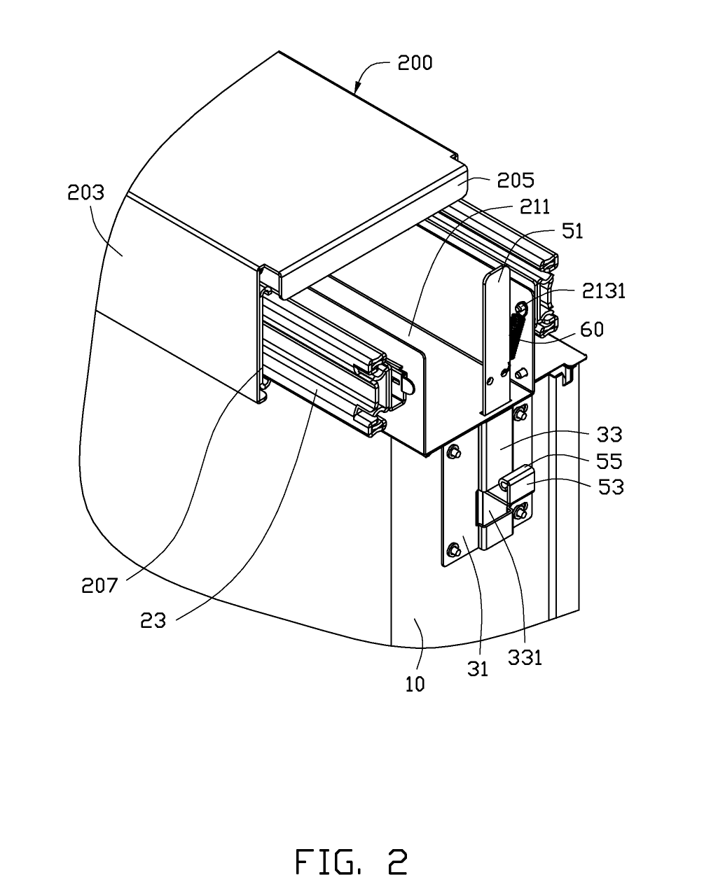

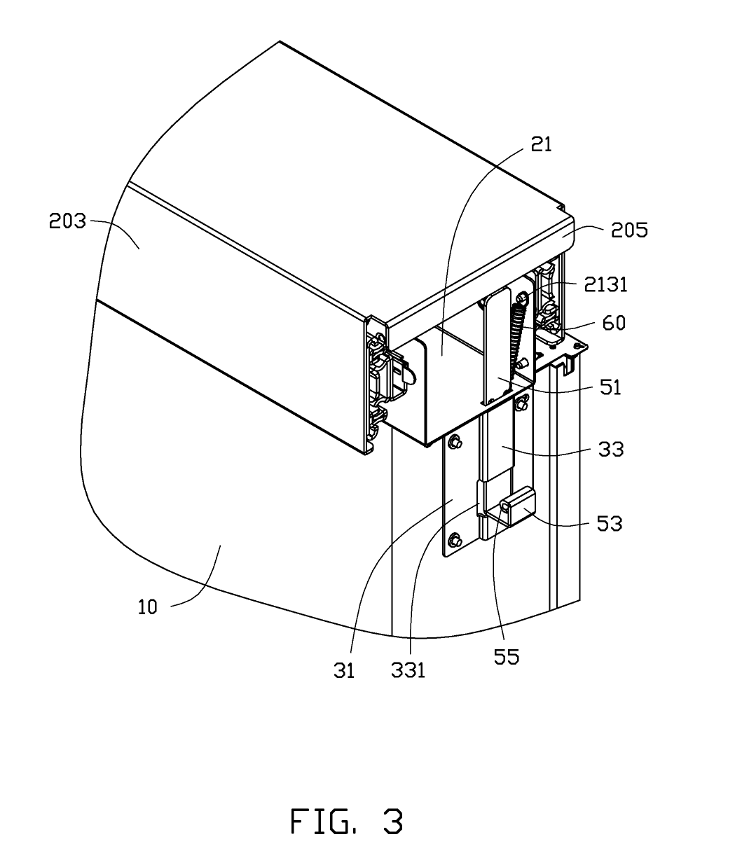

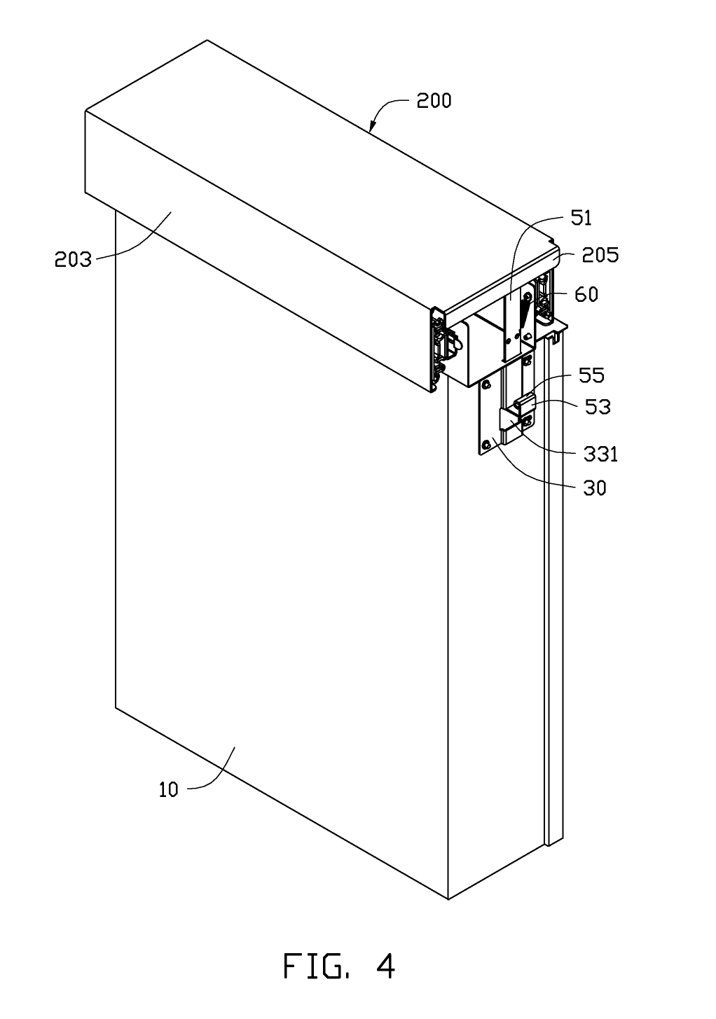

Also referring to FIGS. 2-4, in assembly, the sliding piece 51 is inserted through the insertion slot 2113. The mounting member 30 is moved to be adjacent to the sliding member 50, allowing the operation piece 53 and the rolled portion 55 to extend out of the opening 331. The mounting plate 31 is secured to a side of the channel case 10 by screws or other methods. The sliding piece 51 is received in the receiving slot 313. A first end of the resilient member 60 is secured to the mounting hole 511, and a second end of the resilient member 60 is secured to the post 2131. Thus, the locking assembly 300 is secured to the goods channel module 100. In this position, the connecting piece 52 abuts a top edge of the opening 331, the resilient member 60 is in an initial position, and the sliding member 50 is in a first position.

The sliding assembly 20 is moved to be adjacent to the installation member 200, to align the sliding rail 23 with the slideway 207. The goods channel module 100 is slid into the installation member 200 along a first direction, until the sliding piece 51 abuts an outer surface of the limiting plate 205. In this position, the goods channel module 100 is blocked by the limiting plate 205. The operation piece 53 is pulled to slide the sliding member 50 downwards, until the connecting piece 52 abuts a bottom edge of the opening 331. In this position, the resilient member 60 is elastically deformed, the sliding piece 51 is slid over the limiting plate 205 into a second position. The goods channel module 100 is further slid into the installation member 200 along the first direction, until the sliding rail 23 is completely received in the slideway 207. In this position, the sliding member 50 is released, the resilient member 60 rebounds to slide the sliding piece 51 upwards, until the sliding piece 51 abuts an inner surface of the limiting plate 205, preventing the goods channel module 100 from moving along a second direction opposite to the first direction. Thus, the goods channel module 100 is secured to the installation member 200, and the sliding member 50 is in the first position.

When moving the goods channel module 100, the operation piece 53 is pulled to slide the sliding member 50 into the second position, the sliding piece 51 is slid over the limiting plate 205, and then the goods channel module 100 is removable from the installation member 200.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. A vending machine, comprising:
an installation member comprising a limiting plate;
a goods channel module slidably mounted in the installation member along a first direction; and
a locking assembly comprising a mounting member secured to the goods channel module and a sliding member;
wherein the mounting member defines a receiving slot; the sliding member comprises a sliding piece and an operation piece extending from the sliding piece, the sliding piece is slidably received in the receiving slot, and the operation piece extends out of the mounting member; the operation piece is operable to slide the sliding member between a first position and a second position; when the sliding member is in the first position, the sliding piece extends into the installation member and abuts the limiting plate, preventing the goods channel module from moving along a second direction opposite to the first direction; and when the sliding member is in the second position, the sliding piece disengages from the limiting plate, and the goods channel module is slidable relative to the installation member along the second position.

2. The vending machine of claim 1, wherein the sliding member further comprises a connecting piece, and the connecting piece connects the sliding piece and the operation piece; the mounting member defines an opening, and the connecting piece and the operation piece extend out of the opening; when the sliding member is in the first position, the connecting piece abuts a top edge of the opening; and when the sliding member is in the second position, the connecting piece abuts a bottom edge of the opening.

3. The vending machine of claim 2, wherein the connecting piece is substantially perpendicular to the sliding piece and the operation piece, and the sliding piece is substantially parallel to the operation piece.

4. The vending machine of claim 2, wherein the sliding member further comprises a rolled portion extending from the operation piece.

5. The vending machine of claim 2, wherein the connecting piece and the operation piece are integrated with the sliding piece.

6. The vending machine of claim 1, wherein the locking assembly further comprises a resilient member, a first end of the resilient member is secured to the goods channel module, and a second end of the resilient member is secured to the sliding piece.

7. The vending machine of claim 6, wherein the goods channel module comprises a channel case and a sliding assembly secured to the channel case; the sliding assembly comprises a mounting frame and two sliding rails secured to opposite sides of the mounting frame; the mounting member is secured to the channel case; the mounting frame defines an insertion slot, and the sliding piece extends out of the insertion slot.

8. The vending machine of claim 7, wherein the sliding assembly further comprises a post extending from the mounting frame; the sliding piece defines a mounting hole; the resilient member is located in the mounting frame; and the first end of the resilient member is secured to the post, and the second end of the resilient member is engaged in the mounting hole.

9. The vending machine of claim 8, wherein the post is a screw, which extends out of the mounting frame and secures the two sliding rails to the mounting frame.

10. The vending machine of claim 7, wherein the insertion slot is rectangular.

11. A vending machine, comprising:
an installation member comprising a limiting plate;
a goods channel module slidably mounted in the installation member along a first direction; and
a locking assembly comprising a mounting member secured to the goods channel module, a sliding member slidably mounted to the mounting member, and a resilient member;
wherein the sliding member comprises a sliding piece slidably received between the mounting member and a side surface of the goods channel module; a first end of the resilient member is secured to the sliding piece, and a second end of the resilient member is secured to the goods channel module; the sliding member is slidable between a first position and a second position; when the sliding member is in the first position, the resilient member is in an initial position, and the sliding piece extends into the installation member and abuts the limiting plate, preventing the goods channel module from moving along a second direction opposite to the first direction; and when the sliding member is in the second position, the sliding piece disengages from the limiting plate, the resilient member is elastically deformed, and the goods channel module is slidable relative to the installation member along the second position.

12. The vending machine of claim 11, wherein the sliding member further comprises an operation piece extending from the sliding piece, the mounting member defines a receiving slot, and the sliding piece is slidably received in the receiving slot; and the operation piece extends out of the mounting member and is operable to slide the sliding member between the first position and the second position.

13. The vending machine of claim 12, wherein the sliding member further comprises a connecting piece, and the connecting piece connects the sliding piece and the operation piece; the mounting member defines an opening, and the connecting piece and the operation piece extend out of the opening; when the sliding member is in the first position, the connecting piece abuts a top edge of the opening; and when the sliding member is in the second position, the connecting piece abuts a bottom edge of the opening.

14. The vending machine of claim 13, wherein the connecting piece is substantially perpendicular to the sliding piece and the operation piece, and the sliding piece is substantially parallel to the operation piece.

15. The vending machine of claim 13, wherein the connecting piece and the operation piece are integrated with the sliding piece.

16. The vending machine of claim 12, wherein the sliding member further comprises a rolled portion extending from the operation piece.

17. The vending machine of claim 11, wherein the goods channel module comprises a channel case and a sliding assembly secured to the channel case; the sliding assembly comprises a mounting frame and two sliding rails secured to opposite sides of the mounting frame; the mounting member is secured to the channel case; the mounting frame defines a insertion slot, and the sliding piece extends out of the insertion slot.

18. The vending machine of claim 17, wherein the sliding assembly further comprises a post extending from the mounting frame; the sliding piece defines a mounting hole; the resilient member is located in the mounting frame; and the first end of the resilient member is secured to the post, and the second end of the resilient member is engaged in the mounting hole.

19. The vending machine of claim 18, wherein the post is a screw, which extends out of the mounting frame and secures the two sliding rails to the mounting frame.

20. The vending machine of claim 17, wherein the insertion slot is rectangular.
